(19) United States
(12) Patent Application Publication
(10) Pub. No.: US 2009/0272465 A1
(43) Pub. Date: Nov. 5, 2009

(54) MEMORY METAL PLUG WITH EXTENDED SHAFT

(75) Inventor: Roger Adelman, Villa Hills, KY (US)

Correspondence Address: WOOD, HERRON & EVANS, LLP, 2700 CAREW TOWER, 441 VINE STREET, CINCINNATI, OH, 45202, US

(73) Assignee: DOUGLAS L. HOLLAENDER ENTERPRISES, INC., Loveland, OH (US)

(21) Appl. No.: 12/435,440

(22) Filed: May 5, 2009

Related U.S. Application Data
(60) Provisional application No. 61/050,407, filed on May 5, 2008.

(51) Int. Cl. F16J 13/00

(52) U.S. Cl. 148/402

(57) ABSTRACT

A memory metal plug adapted to seal tubes includes a central shaft and a plurality of discs extending radially from said shaft. The shaft extends beyond the first and last disc. The juncture of the discs and the shaft is radiused, and, further, the thickness of the discs decreases near the perimeter of each disc. This allows the discs to be swaged significantly without breaking, which, in turn, facilitates their use in plugging tubes.

### RELATED APPLICATION

This application is related to and claims the benefit of U.S. Provisional Patent Application Ser. No. 61/050,407, filed May 5, 2008, the disclosure of which is incorporated herein by reference.

### BACKGROUND OF THE INVENTION

Frequently, it is necessary to plug or seal a tube or circular opening. Plugs can be used to seal bores formed in diesel engines, such as the plug disclosed in U.S. Pat. No. 6,053,992. Plugs are also used to seal tubes in heat exchangers. There are a wide variety of different methods used to seal such devices, none of which are totally satisfactory. In certain applications, explosive devices are used to seal off a tube. But, this is very expensive. Mechanical devices can also be used; but, in high pressure applications, these may fail.

A potentially useful plug to seal tubes is disclosed in Hall U.S. Pat. No. 5,189,789. This discloses the use of a memory metal or Nitinol plug. Memory metals are alloys that undergo a reversible transformation from an austenitic state to a martensitic state with changes in temperatures. At colder temperatures, the alloy enters the martensitic state and reverts to the austenitic state at higher temperatures. A plug in the martensitic state can be bent or shaped. When the metal reverts to the austenitic state it reverts to its original shape.

The plug disclosed in Hall U.S. Pat. No. 5,189,789 is formed from such a memory metal and includes a central post with a plurality of disks that extend perpendicular to the post. The disclosed plug is placed in a bath of methanol and dry ice to cause it to enter the martensitic state. It is then forced through a die which bends or swages the disks, decreasing the exterior diameter of the plug. The plug can then be manually place into a tube and heated, causing it to revert to the austenitic state at which point in time it will bend back to its original shape, increasing its diameter and, thus, plugging the tube. These plugs are preferably formed from Nitinol, which is an alloy of nickel and titanium.

Unfortunately, the plug disclosed in the Hall reference tends to break when swaged. The design of the plug as well as the disclosed method of swaging the plug produced very unreliable results.

Further, it is desirable to maximize the diameter reduction of the plug.

### SUMMARY OF THE INVENTION

The present invention comprises a memory metal plug which includes a central shaft with a plurality of discs extending from the central shaft. The shaft itself has two opposed nubs or bosses that extend beyond the first and last disk. The juncture of each disc and shaft is radiused to minimize breakage.

The deformed plug connected to a heat conducting holder is inserted into a tube. The plug is heated, causing the plug to revert to the austenitic state and into its original configuration, thus expanding and sealing the tube.

The objects and advantages of the present invention will be further appreciated in light of the following detailed description and drawings, in which:

### BRIEF DESCRIPTION OF THE DRAWING

FIG. 1 is a perspective view of a plug for use in the present invention;

FIG. 2 is a diagrammatic depiction of the insertion of the plug of the present invention into a tube;

FIG. 3A is a cross sectional view of a Nitinol plug inserted into a tube in the swaged condition, as shown in FIG. 3.

FIG. 3B is a cross sectional view of a Nitinol plug inserted into a tube in its austenitic unswaged configuration.

### DETAILED DESCRIPTION

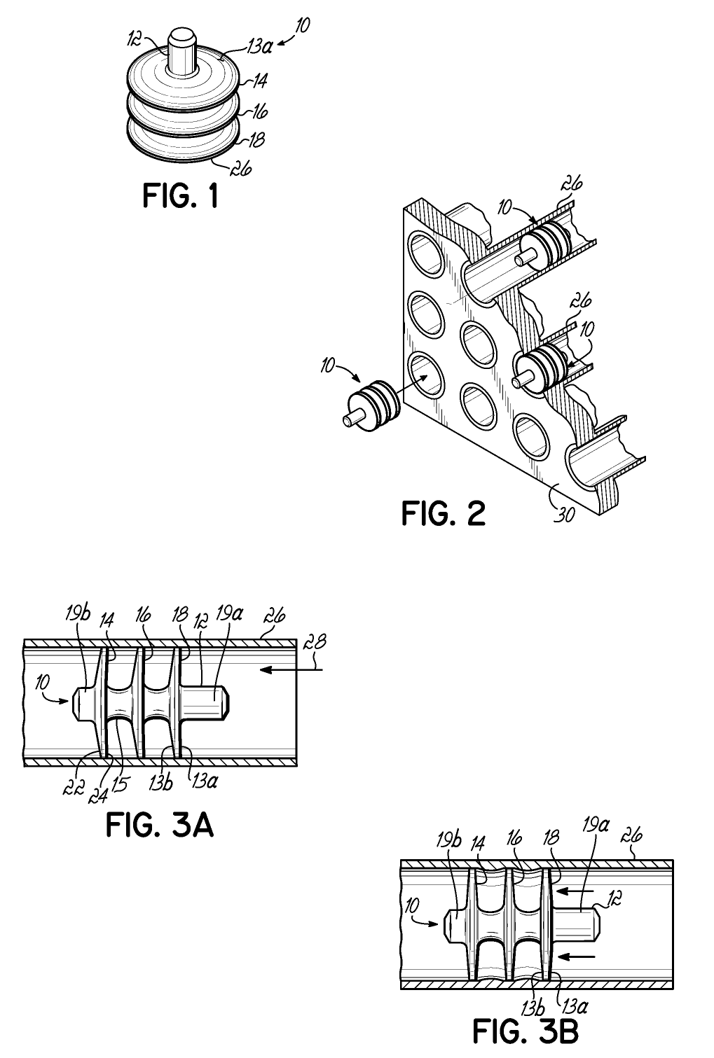

As shown in FIG. 1, a plug 10 includes a central shaft 12 and first, second and third circular disks 14,16, and 18. The plug 10 is shown with three disks. Two or more disks help align the plug in use.

The shaft 12 extends beyond first disc 14 and third or last disc 18 providing posts or bosses 19a and 19b. Each of the first, second and third disks have first and second surfaces 13a and 13b. At the junctures between the surfaces and shaft 12 are radiused portions 15. The radiused portions are located at each juncture between the shaft and the disks.

Each of these radiuses should be greater than 0.003 inch, more preferably greater than 0.015 inch, and, in a preferred embodiment, is greater than about 0.03 inch. As shown, the radiuses are about 0.093. These radiused portions provide stress relief in both the deformation of the plug 10, and during use of the plug 10. This allows the plug to be deformed more, thus further reducing the diameter of the deformed plug.

Generally, for a plug having a diameter of 1 inch, the shaft 12 will have a diameter of 0.09 to 0.3 inch and the disks will be 0.026 to 0.032 inch thick at the edge of the radiused portion. For a 0.5 to 1 inch diameter plug, a thickness of 0.187 functions well. A thinner disk can be swaged more. But, plugs with thick disks withstand higher pressures.

The thickness of each disc can decrease from the central shaft 12 to the distal edge 26 of each disc. The amount of tapering is designed to maximize the ability of the plug to be swaged without the discs cracking.

Plug 10 is formed from a memory metal alloy. As discussed below, it is important to select a memory metal alloy that has an appropriate temperature profile so that the conversions between the martensitic state and austenitic state are accomplished at temperatures that make the plug 10 commercially useful. Preferably, the memory metal is Nitinol. Such memory metals can be purchased. One supplier of such materials is Special Metals, Shape Memory Alloy Division, located in New Hartford, N.Y. A preferred material is one with 50 mole percent nickel and 50 mole percent titanium.

Preferably, plug 10 is machined from Nitinol which converts to the martensitic state at about 0° F., and remains in the martensitic state until heated to a temperature of about 95° F., or higher. Such material is generally purchased as bar stock or rod stock, and must be further machined in its austenitic state to provide a plug 10, as shown in FIG. 1. In order to form such a plug, a rod of the material having the desired cross sectional dimension is machined using, for example, a CNC lathe screw machine or grinder to provide the plug 10 with shaft 12 and a plurality of disks 14, 16 and 18 (as shown). The leading peripheral 22 edges of these disks are radiused to facilitate swaging. The trailing peripheral edges 24 are not radiused. This provides a better seal in use.

During the machining of these plugs 10 the temperature profile may be modified. Accordingly, after machining, the plugs 10 are subjected to a heat treatment to restore the shape memory response of the alloy. Preferably, subsequent to machining, the plug 10 is heated to a temperature of about 900° F. for a period of 30 minutes.

Initially, plug 10 in its austenitic state with the discs in the fully extended position, as shown in FIG. 1. The diameter of the discs 14, 16, and 18 are reduced by forcing the plug through a tapered cylindrical die. In order to do so, the metal in the plug is transformed into martensite by reducing the temperature of the plug to at least 0° F. While in the martensitic state, the plug is forced through the die, causing the discs 14-16 to bend inwardly, as represented by the plug shown in FIG. 3A. Because the discs 14-18 have a tapered cross sectional configuration, they can be bent more, thereby allowing the external diameter of the swaged plug to be significantly smaller than the cross sectional diameter of the unswaged plug, as shown in FIG. 1 and FIG. 3B.

A suitable apparatus to swage the plugs is disclosed in co-pending published application 2007/0125461 A1, entitled Memory Metal Plug, application Ser. No. 11/396,739, filed Apr. 3, 2006, the disclosure of which is hereby incorporated by reference.

To use the plug 10 to seal a tube, the deformed plug 10, in the martensitic state, is inserted in the direction of arrow 28 into a tube 26, which may be part of a heat exchanger 30, as shown in FIG. 3A. This can be done manually using a holding rod or with a mechanical holder/heater, such as that disclosed in pending application Ser. No. 12/037,704, entitled, “Method and Apparatus for Installing Nitinol Plug”, filed Feb. 26, 2008, the disclosure of which is incorporated herein. The deformed plug should be of a size wherein the outer diameter of the deformed plug is about 0.03 inches less than the inner diameter of the tube.

Once inserted into the tube with the holder 84 still in position, the plug is heated to a temperature effective to cause the plug to convert to the austenitic state. When the temperature of the plug reaches the transition temperature to the austenitic state about 95° F., the plug 10 reverts to its original condition, increasing its diameter and, in turn, pressing against the side walls of tube 26 as shown in FIG. 3B.

The plug 10 remains seated in tube 26 during repeated heating and cooling cycles, providing a reliable seal. This, in turn, allows a heat exchange tube which has a leak to be sealed off quickly and reliably, allowing the heat exchanger to be put back into operation quickly and inexpensively.

This has been a description of the present invention along with the preferred method of practicing the present invention. However, the invention itself should only be defined by the appended claims,

Wherein we claim:

1. A memory metal plug comprising a central axial shaft and a plurality of discs extending radially outward from said shaft wherein a portion of said shaft extends beyond a first of said discs and a second portion of said shaft extends beyond a second portion of a last disc;
wherein said plugs include a radius between each surface of each plug and said shaft.

2. The plug claimed in claim 1 wherein said discs have a thickness which decreases from said radius to peripheral edges of said discs.

3. A memory metal plug comprising a central axial shaft and a plurality of discs extending radially outward from said shaft
radiused portions at junctions between said shaft and said lens;
wherein said discs have a thickness which decreases from said radiused portions to peripheral edges of said discs.
